(19) United States
(12) Patent Application Publication
(10) Pub. No.: US 2025/0016075 A1
(43) Pub. Date: Jan. 9, 2025

(54) USE CASES TRACKING IN A DISTRIBUTED ENVIRONMENT

(71) Applicant: Telefonaktiebolaget LM Ericsson (publ), Stockholm (SE)

(72) Inventors: Fabio ACQUARONE, Genova (IT); Paolo BOTTARO, Genova (IT); Andrea PETRONIO, Genova (IT)

(21) Appl. No.: 18/712,373

(22) PCT Filed: Nov. 24, 2021
(86) PCT No.: PCT/IB2021/060941

§ 371 Date: May 22, 2024

(51) Int. Cl. H04L 43/04; H04L 43/20; H04L 43/55

(52) U.S. Cl. CPC H04L 43/04; H04L 43/20; H04L 43/55

(57) ABSTRACT

Methods for managing telecommunication networks are disclosed herein and are implemented by a network node executing an atomic function in a distributed workflow. The network node receives input data for processing by the atomic function. If the input data does not include a use case indicator, the network node generates one. If the input data does include a use case indicator, the network node extracts that information from the input data. Regardless of whether the use case indicator is received or generated, however, network node employs the use case indicator to generate a trace record for the particular use case instance. The trace record is then sent to be correlated with other trace records generated for the use case by one or more other network nodes processing the use case in a distributed network flow.

### TECHNICAL FIELD

The present disclosure relates generally to the management of telecommunication networks, and more particularly to tracing functionality for tracing and troubleshooting use cases executing in a distributed network flow.

### BACKGROUND

Software applications are used to control the processing associated with many different types of vertical and horizontal markets. For example, the processing associated with manufacturing operations, commercial operations, communications, health care, and mobility, are all controlled, at least in part, by software applications. Recently, the complexity of these types of software applications has increased, especially in environments where a plurality of software modules interact with each other over distributed platforms.

Tracing a workflow associated with these types of software applications is key for monitoring, troubleshooting, and logging purposes. Specifically, the data produced by tracing mechanisms play an important role in understanding system behavior. Like the so-called “black boxes” used in avionics, which are essential for recreating the actions of a pilot and operation of an aircraft after a disaster has occurred, the analysis of logging information is fundamental to troubleshooting an application workflow both during development and production phases.

Industry and social trends are currently placing additional, more stringent requirements on tracing functionality. Further, such requirements are generally applicable across a wide array of technologies. For example, for virtualization technologies, tracing capabilities should be able to handle stacked layers and functions associated with cloud computing dynamic resource allocation. For 5G technologies, tracing capabilities should be able to handle issues related to latency, bandwidth monitoring, and mobile-to-mobile (M2M) scenarios. For autonomous technologies, such as autonomous driving, tracing capabilities should be configured to handle the processing associated with various types of vehicles, such as cars, ships, trains, and aircraft. Additionally, for e-commerce technologies, tracing capabilities should be able to handle workflows in Internet-Of-Things (IoT) networks, which typically comprise one or more Wireless Sensor Networks (WSNs).

Currently, the evolution of tracing with respect to controlling software applications is occurring in parallel with an escalating attention to the various security and privacy aspects of such applications. For example, the treatment of personal sensitive data by controlling software applications, as well as other applications, is rapidly evolving. This treatment is largely driven by, and subject to, a wide set of regulations that generally vary according to the nation imposing the regulations.

In another example, consider industrial and commercial information (e.g., configuration information, volumes, and deployment details). Although this type of data and information may not be subject to the same privacy regulations that apply to people, it still can be sensitive and in need of protection. For example, a business owner may not want to expose business-related information to competitors. In some cases, the business-related data and information may even be vulnerable to hackers, regardless of whether they are individual and/or supported by a hostile nation. Moreover, the damages related to cyberattacks are well known to individuals and companies alike, and therefore, security is at or near the top of practically every company's agenda.

Therefore, tracing the functionality of software applications as they process data, with respect to security and other aspects, is an important function. This is especially true for distributed networks.

### SUMMARY

The present disclosure relates to tracing functionality in a distributed network environment. In particular, the embodiments described herein replace conventional software-module driven tracing methodologies used in a distributed network environment with a use-case driven tracing methodology. In doing so, the present embodiments provide an accurate view of how the software applications behave in distributed networks on a stand-alone basis as well as in concert with other software applications executing in the distributed networks. Additionally, embodiments of the present disclosure are designed to provide users with particularly salient information while eliminating the “noise” and other superfluous information typically produced by conventional tracing systems.

Accordingly, a first aspect of the present disclosure provides a method for managing telecommunication networks. The method, which is implemented by a network node executing an atomic function in a distributed workflow, comprises generating a use case indicator for a use case associated with the distributed workflow. The use case indicator identifies the use case and a particular instance of the use case. The method further comprises processing data input data associated with the use case according to the atomic function to generate output data. The atomic function is associated with tracing in the distributed workflow and comprises a set of uninterruptible instructions executable by the network node. Based on the processing, the method then comprises generating a trace record comprising the use case indicator, and sending the trace record to be correlated with one or more other trace records generated for the use case by other atomic functions. In this embodiment, correlating the trace records is based on the use case indicator.

A second aspect of the present disclosure provides a method for managing telecommunication networks. In this aspect, the method is implemented by a network node executing an atomic function in a distributed workflow and comprises receiving input data associated with a use case of the distributed workflow. The input data comprises a use case indicator identifying a particular instance of the use case. The method then comprises processing the input data according to the atomic function to generate output data. The atomic function is associated with tracing in the distributed workflow and comprises a set of uninterruptible instructions executable by the network node. Based on the processing, the method then comprises generating a trace record comprising the use case indicator and sending the trace record to be correlated with one or more other trace records generated for the use case by other atomic functions. In this embodiment, correlating the trace records is based on the use case indicator.

A third aspect of the present disclosure provides a non-transitory computer readable medium comprising instructions for managing telecommunication networks thereon. When executed by processing circuitry of a network node executing an atomic function in a distributed workflow, the instructions configure the network node to generate a use case indicator for a use case associated with the distributed workflow. The use case indicator identifies the use case and a particular instance of the use case. The instructions further configure the network node to process data input data associated with the use case according to the atomic function to generate output data. The atomic function is associated with tracing in the distributed workflow and comprises a set of uninterruptible instructions executable by the network node. Additionally, the instructions configure the network node to generate, based on the processing, a trace record comprising the use case indicator, and send the trace record to be correlated with one or more other trace records generated for the use case by other atomic functions. In this embodiment, the trace records are correlated based on the use case indicator.

A fourth aspect of the present disclosure provides a network node in a distributed communications environment for managing telecommunication networks. The network node is configured to execute an atomic function in a distributed workflow and to generate a use case indicator for a use case associated with the distributed workflow, wherein the use case indicator identifies the use case and a particular instance of the use case, process data input data associated with the use case according to the atomic function to generate output data, wherein the atomic function is associated with tracing in the distributed workflow and comprises a set of uninterruptible instructions executable by the network node, based on the processing, generate a trace record comprising the use case indicator, and send the trace record to be correlated based on the use case indicator with one or more other trace records generated for the use case by other atomic functions.

A fifth aspect of the present disclosure provides a network node in a distributed communications environment for managing telecommunication networks. The network node is configured to execute an atomic function in a distributed workflow and comprises communication circuitry and processing circuitry. The communication circuitry enables communication with one or more other atomic functions in the distributed communications environment. The processing circuitry is configured to generate a use case indicator for a use case associated with the distributed workflow, wherein the use case indicator identifies the use case and a particular instance of the use case, and process data input data associated with the use case according to the atomic function to generate output data, wherein the atomic function is associated with tracing in the distributed workflow and comprises a set of uninterruptible instructions executable by the network node. Additionally, based on the processing, the processing circuitry is configured to generate a trace record comprising the use case indicator and send the trace record to be correlated based on the use case indicator with one or more other trace records generated for the use case by other atomic functions.

A sixth aspect of the present disclosure provides a computer program comprising executable instructions that, when executed by a processing circuitry in a network node, causes the network node to perform the method according to the first aspect.

A seventh aspect of the present disclosure provides a carrier containing a computer program according to the sixth aspect, wherein the carrier is one of an electronic signal, optical signal, radio signal, or computer readable storage medium.

An eighth aspect of the present disclosure provides a non-transitory computer readable medium comprising instructions thereon for managing telecommunication networks. When executed by processing circuitry of a network node executing an atomic function in a distributed workflow, the instructions configure the network node to receive input data associated with a use case of the distributed workflow, the input data comprising a use case indicator identifying a particular instance of the use case, and process the input data according to the atomic function to generate output data, wherein the atomic function is associated with tracing in the distributed workflow and comprises a set of uninterruptible instructions executable by the network node. Additionally, the instructions, when executed by the processing circuitry configure the network node to generate, based on the processing, a trace record comprising the use case indicator and send the trace record to be correlated with one or more trace records generated for the use case by other atomic functions.

A ninth aspect of the present disclosure provides a network node in a distributed communications environment for managing telecommunication networks. In one embodiment, the network node is configured to execute an atomic function in a distributed workflow and to receive input data associated with a use case of the distributed workflow. In this embodiment, the input data comprises a use case indicator identifying a particular instance of the use case. The network node is also configured to process the input data according to the atomic function to generate output data. In this embodiment, the atomic function is associated with tracing in the distributed workflow and comprises a set of uninterruptible instructions executable by the network node. Additionally, the network node is configured to generate, based on the processing, a trace record comprising the use case indicator and send the trace record to be correlated with one or more trace records generated for the use case by other atomic functions.

A tenth aspect of the present disclosure provides a network node in a distributed communications environment for managing telecommunication networks. In one embodiment, the network node is configured to execute an atomic function in a distributed workflow and comprises communication circuitry and processing circuitry. The communications circuitry is configured to enable communication with one or more other atomic functions in the distributed communications environment. The processing circuitry is configured to receive input data associated with a use case of the distributed workflow, the input data comprising a use case indicator identifying a particular instance of the use case, and process the input data according to the atomic function to generate output data, wherein the atomic function is associated with tracing in the distributed workflow and comprises a set of uninterruptible instructions executable by the network node. Additionally, based on the processing, the processing circuitry is configured to generate a trace record comprising the use case indicator and send the trace record to be correlated with one or more trace records generated for the use case by other atomic functions.

An eleventh aspect of the present disclosure provides a computer program comprising executable instructions that, when executed by a processing circuitry in a network node, causes the network node to perform the method according to the second aspect.

A twelfth aspect of the present disclosure provides a carrier containing a computer program according to the eleventh aspect, wherein the carrier is one of an electronic signal, optical signal, radio signal, or computer readable storage medium.

### BRIEF DESCRIPTION OF THE DRAWINGS

FIG. 1 illustrates a distributed network system configured according to one aspect of the present disclosure.

FIG. 2 illustrates a system for processing a use case in a distributed network environment according to one aspect of the present disclosure.

FIGS. 3A-3C illustrate examples of trace logs generated by a plurality of corresponding functions.

FIG. 4 illustrates an exemplary correlated trace log generated according to one aspect of the present disclosure.

FIG. 5 is a flow diagram illustrating an exemplary method for generating a trace record by an initiator node according to one aspect of the present disclosure.

FIG. 6 is a flow diagram illustrating an exemplary method for generating a trace record by a continuer node according to one aspect of the present disclosure.

FIG. 7 is a schematic diagram illustrating some exemplary components of a network node configured to implement aspects of the present disclosure.

FIG. 8 is a functional block diagram illustrating a network node configured to implement aspects of the present disclosure.

### DETAILED DESCRIPTION

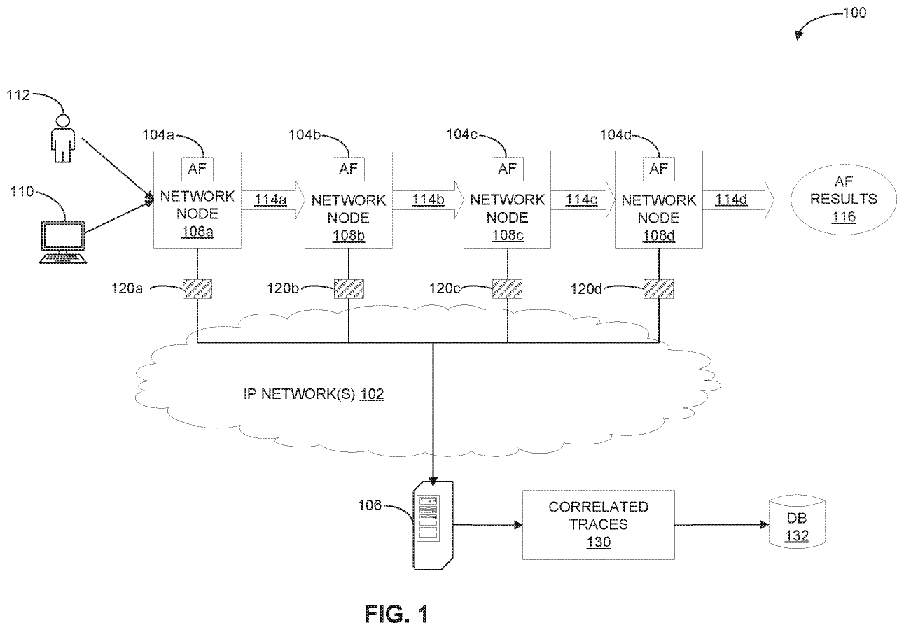

Referring now to the drawings, and particularly to FIG. 1, an exemplary distributed network 100 is shown. The distributed network 100 comprises one or more IP networks 102 communicatively interconnecting a plurality of network nodes 104a-104d to a correlation server 106. Each of the network nodes 104a-104d comprises a respective atomic function (AF) 108a-108d that processes data according to its particular instructions. Each AF 108a-108d also provides a corresponding output 114a-114c that is received as input by a corresponding downstream AF 104b-104d.

As described herein, the network nodes 104a-104d may be in the same communications network or they may be distributed throughout one or more different communications networks. Similarly, AFs 108a-108d may be disposed on and executed by the processing circuitry of a single network node 104, or on different network nodes 104 and distributed throughout one or more different communications networks. Regardless, the present embodiments configure network nodes 104a-104d to generate trace records at particular trace points. Each generated trace record is associated with a particular “use case” and is correlated with other trace records generated for the use case.

A “use case,” as defined herein, is a scenario in which a system such as distributed network 100 receives an external request and responds to it. For example, a use case may be a user checking the configuration of a node or software application. Another example of a use case is a node raising an alarm. Still other examples of uses cases include, but are not limited to, a user registration process for a streaming platform, storing the high score of a videogame to memory, establishing a communication link for a video conferencing application, and communicating video data during an established video conferencing session.

Regardless of the particular use case, though, an “initiator” starts the use case. As seen in FIG. 1, for example, an “initiator” may be a user input terminal 110, a user 112, or the like. The initiator begins a use case by providing input data, for example, to network node 104a. The AF 108a in network node 104a then processes the input data according to its programming and sends any resultant output data 114a to the next downstream network node 104b for input into AF 108b. Upon receipt, AF 108b performs its processing and provides its output data 114b to network node 104c. This process continues with the AF 108 in each network node 104 processing the input data it receives and providing corresponding output data 114a-114d to the next network node 104 for processing by the next AF 108. When the AFs 108 have finished processing, the output is provided in the AF Result 116.

In the context of the present disclosure, an “atomic function” 108 is the smallest possible piece of code (e.g., a code module, function, etc.) that when executed by the processing circuitry of a corresponding network node 104, performs some specific task in support of a use case. That is, each AF 108a-108d comprises a set of uninterruptible instructions executable by the network node. For example, consider a use case example in which a user's high score is to be saved to a database. In such a use case, AF 108a-108d may comprise the code required to, respectively, open a database, read a database record (e.g., a high score record) from the database, write data (e.g., a new high score) to the database record, and update the database with the updated database record. In each case, the processing circuitry of a network node 104 executes the programming of its corresponding AF 108 from beginning to end without interruption. Regardless of its particular task or functionality, however, each AF 108 comprises a set of uninterruptible instructions executable by the network node.

In addition to the programming for its intended function, each AF 108a-108d is specifically configured to generate one or more trace records 120a-120d at particular trace points during the distributed call flow. Each trace record, which will be described in more detail later, is sent by a corresponding one of the AFs 108 to correlation server 106 via IP network(s) 102. Upon receipt, correlation server 106 correlates the individual trace records 120a-120d into a unified trace record 130 for storage in a database 132. Thereafter, a user such as a systems analyst, for example, can retrieve and analyze the correlated trace records 130 from DB 132 to troubleshoot a use case, for example.

The network nodes 104a-104d seen in FIG. 1 play different roles with respect to use case processing at runtime in distributed network 100. For example, network node 104a fulfills an “initiator role.” In the initiator role, AF 108a of network node 104a processes the received input data and generates a use case indicator for the use case. As described in more detail later, the use case indicator is unique to a use case and identifies the use case and the particular instance of the use case. At the other end of the distributed workflow, network node 104d fulfills a “terminator role.” In the terminator role, AF 108d receives the output provided by upstream AF 108c, processes it, and generates output 114d for AF results 116. The remaining network nodes 104b-104c fulfill “continuer roles.” In this role, each AF 108b, 108c processes incoming data and generates appropriate output to send as input to the next downstream AF 108.

Regardless of their particular role, however, network nodes 104b-104d do not alter the unique use case indicator once it has been generated. Thus, the generated use case indicator remains unchanged by the processing of any of the in downstream AFs 108b-108d. This is because the use case indicator, according to the present embodiments, is sent to correlation server 106 in the trace records 120 where it is used to generate the correlated trace record 130. Thus, the use case indicator uniquely identifies a complete trace for any given use case.

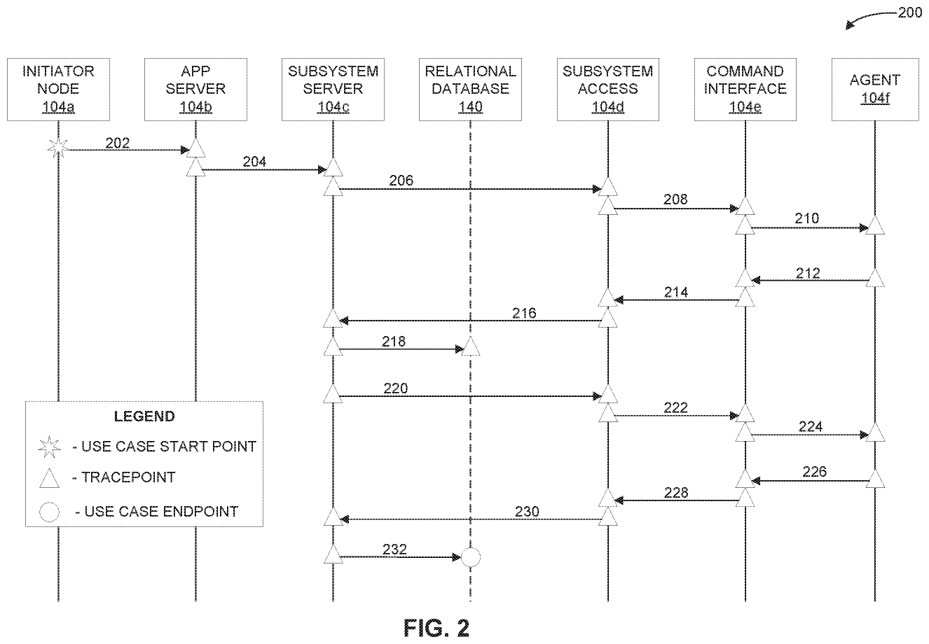

FIG. 2 is a signaling diagram illustrating a system 200 for processing a use case in a distributed network environment according to one aspect of the present disclosure. As seen in FIG. 2, system 200 comprises a plurality of network nodes 104a-104f. These include an initiator node 104a, an application server (AS) node 104b, a subsystem server node 104c, a subsystem access node 104d, a command interface node 104e, and an agent node 104f.As stated above, each network node 104a-104f comprises a corresponding AF 108 that when executed by its network node 104 performs its respective tasks associated with a given use case. Additionally, according to the present embodiments, each AF 108 also causes network node 104 to generate and send one or more trace records 120 to correlation server 120.

In more detail, initiator node 104a initiates the execution of a use case by sending a Global Synchronization Request message to AS 104b (line 202). As stated above, an AF 108 executed by the initiator node 104a generates a use case indicator that is unique to the use case and forwards the indicator to AS node 104b in the Global Synchronization Request message. Upon receipt, the AF 108 executed by AS node 104b extracts the use case indicator from the incoming request and generates a first trace record at a first trace point, indicated by the ‘A’ in FIG. 2. In this aspect, the first trace record 120 includes the unique use case indicator and may indicate, for example, that AS node 104b received the request message from initiator node 104a.

AS node 104b also processes the received Global Synchronization Request message and outputs a Subsystem Synchronization Request message to the subsystem server node 104c (line 204). Additionally, AS node 104b generates a second trace record 120 at a second trace point and sends it to correlation server 106. In this aspect, the second trace record 120 also includes the unique use case indicator as well as some descriptive text indicating that AS node 104b has sent the Subsystem Synchronization Request message to the subsystem server node 104c.

AF 108, which is being executed by subsystem server 104c, then processes the incoming request data and generates a System Access Request message to send to the subsystem access node 104d (line 206). Upon receipt, subsystem access node 104d processes the input data and generates and sends a subunit request message to the command interface node 104e (line 208), which then generates a Get Configuration Request message to send to the agent node 104f (line 210). The various nodes then return appropriate, corresponding response messages that may, for example, provide the requested data (lines 212, 214, 216). The results of the AF 108 processing may then be stored in a relational database 240.

As part of the use case scenario of FIG. 2, the subsystem server node 104c may generate and send a further request message to the subsystem access node 104d (line 220), which in turn, causes the downstream nodes 104d and 104e to generate and send corresponding request messages to their downstream nodes (lines 222, 224). The agent node 104f and the other nodes 104e and 104d then generate and send appropriate response messages (lines 226, 228, 230) before subsystem server node 104c sends a command along with the processed data to relational database 140 to store the processed data (line 232).

Regardless of whether a message is a request message, a response message, or some other type of message, the information sent with the messages comprises the unique use case indicator initially generated by initiator node 104a. As stated above, the unique case indicator identifies the particular use case and the particular instance of the use case, and remains unchanged by the AFs 108 during processing. Additionally, each AF 108 generates one or more trace records 120 at corresponding trace points (indicated in FIG. 2 by the “A”) and sends those trace records to correlation server 106.

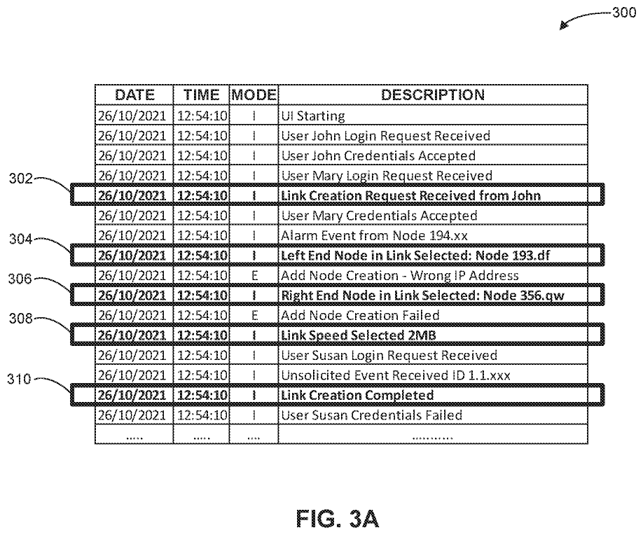

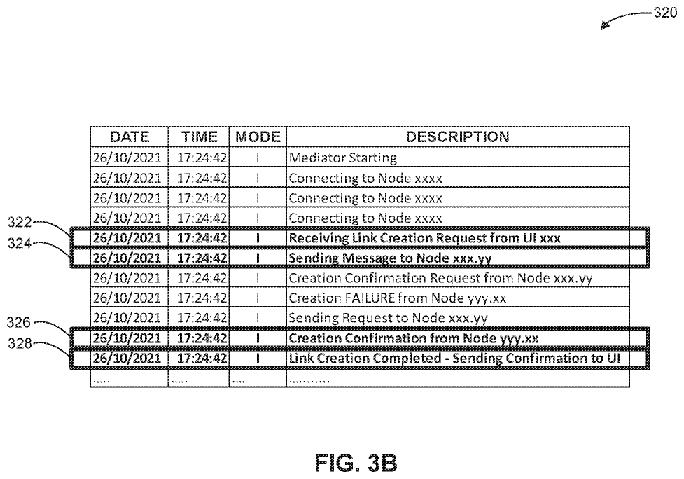

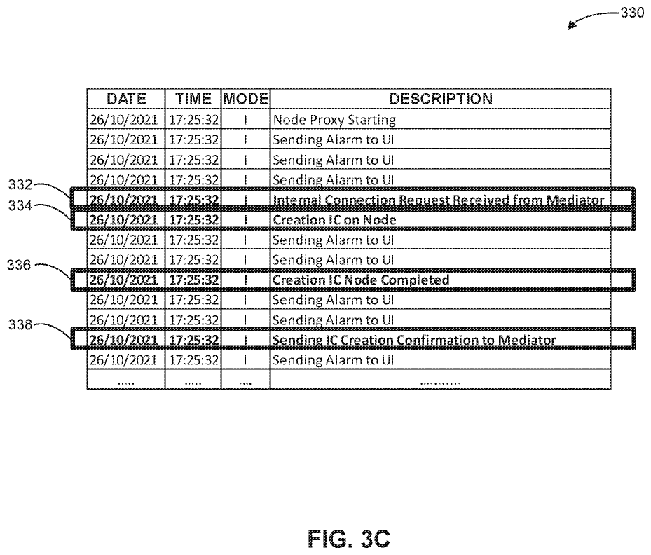

FIGS. 3A-3C illustrate examples of trace logs 300, 320, 330 generated by a plurality of corresponding functions. As seen in these figures, conventional logging processes capture and save information associated with the execution of a plurality of different uses cases. Each log entry, as seen in FIGS. 3A-3C, includes the data and time the record was generated, the so-called “operating” mode of the node executing the function, and some descriptive identifying that function.

Historically, such information has been used for troubleshooting and monitoring purposes, for example. However, it is difficult, if not impossible, to meaningfully analyze the data in such logs. For example, conventional tracing techniques provide a large amount of information. The provided information is not tied to a particular use case or instance of a use case, though. Therefore, conventional tracing techniques often provide way more data than is usable. Such large amounts of data may also require some amount of pre-processing to eliminate redundant entries, as well as entries that are not related to a use case of interest.

For example, log entries 302-338 seen in FIGS. 3A-3C are associated with a single use case of interest. However, the other entries (not particularly numbered) in the trace logs 300, 320, 330 are associated with one or more other use cases. Such entries are “irrelevant” to the use case of interest and do not need to be in the same trace log 300, 320, 330. The present embodiments, however, address eliminating such irrelevant data, and therefore, greatly reducing the complexity of an analysis as well as the amount of resources need for such analyses.

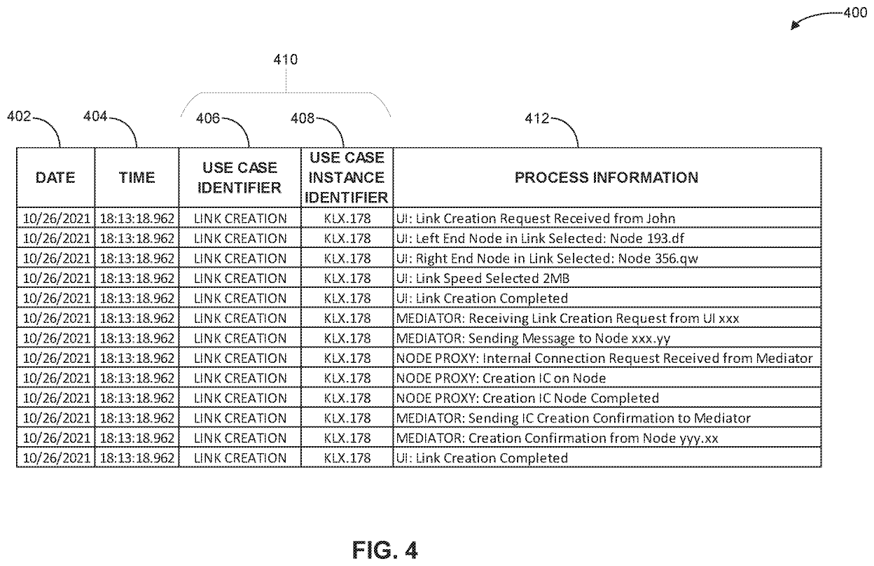

FIG. 4, for example, illustrates an exemplary correlated trace log 400 generated by correlation server 106 according to one aspect of the present disclosure. In this aspect, correlated trace log 400 comprises a plurality of correlated trace records 120. The information included in each record comprises the date 402 and time 404 the record was created, a use case indicator 410, and descriptive process information 412. The use case indicator 410 may comprise any data needed of desired so long as it uniquely identifies the use case that generated it. In one embodiment, use case indicator 410 comprises a use case identifier 406 that identifies the particular use case, and a use case instance identifier 408 that identifies the particular instance of the use case.

As previously described, the use case indicator 410 is generated by network node 104a in its role as the “initiator node.” The indicator is then subsequently provided to the downstream nodes 104 for processing by the downstream AFs 108 executing in the downstream network nodes 104. In one embodiment, the use case indicator 410 is pre-determined and is passed to the downstream AFs 108 in the headers of the output messages. Although each AF 108 will use the unique use case indicator 410 to generate one or more trace records, the use case indicator 410 will remain unchanged by AF 108 processing throughout the distributed workflow.

The use case identifier 406 and the use case instance identifier 408 may comprise any data needed or desired, so long as it is unique to a particular use case. For example, use case identifier 406 may comprises any alpha-numeric phrase including, but not limited to:
a label, descriptive or non-descriptive, associated with the use case;
a link ID associated with the use case; and
a report ID associated with an alarm detected by the network node.

The use case instance identifier 408 is also unique to the case. By way of example only, a use case instance identifier 408 may comprise a value indicating one or more of the following:
a process ID assigned to the particular use case instance;
a randomly generated alphanumeric ID; and
a pre-determined descriptive or non-descriptive label.

Of course, those of ordinary skill in the art will readily appreciate that these are merely examples, and that the present disclosure is not limited as to the data that can be used for a unique use case indicator 410.

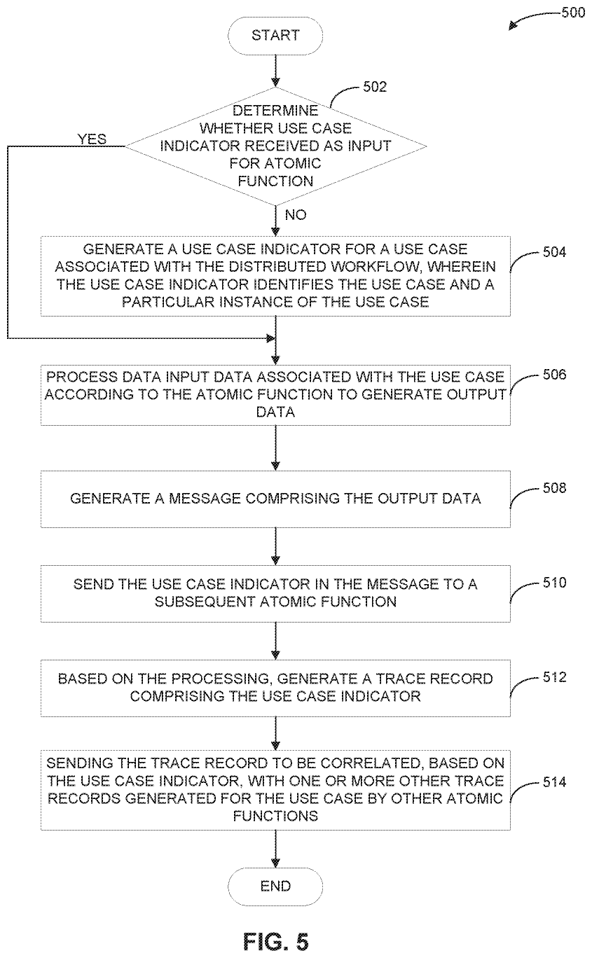

FIG. 5 is a flow diagram illustrating an exemplary method 500 for generating a trace record 120 by a network node 104a performing an initiator role according to one aspect of the present disclosure. As seen in FIG. 5, network node 104a first determines whether it has received a use case indicator 410 as input for AF 108a (box 502). As stated above, the use case indicator 410 is unique to a particular use case and instance of that use case and will remain unchanged throughout processing by each of the AFs 108 in the distributed workflow. If no use indicator 410 is received, network node 104a generates a use case indicator 410 for the use case associated with the distributed workflow (box 504). The generated use case indicator 410 identifies both the use case and the particular instance of the use case. The AF 104a then processes the input data associated with the use case, in accordance with its programming, to generate output data (box 506) and generates an output message 114a comprising the output data (box 508). The generated output message 114a is then sent to a subsequent AF (box 510). In one embodiment, the generated output message is sent to a downstream AF such as AF 108b in network node 104b. In other embodiments, however, the downstream AF is also executing on the same network node 104a. Regardless of whether the downstream AF is on the same network node 104a, or on a different network node 104b, however, the generated use case indicator 410 is included in the generated output message sent to the downstream AF.

Additionally, based on the processing performed by the AF 108a, network node 104a generates a trace record 120a comprising the generated use case indicator 410 (box 512). As previously described, the trace record 120a may be generated to include any desired information, but in this embodiment, is generated to include the date and the time the AF 104a performed a particular action, the unique use case indicator 410 generated for the use case, including the use case identifier 406 and the use case instance identifier 408, and a description of the process associated with the trace record 120a. The trace record 120a, once generated, is sent to the correlation server 106 to be correlated with one or more other trace records 120 generated and sent by other AFs 108 on the same or other network nodes 104 (box 514). As previously described, the trace records 120 are correlated based on the use case indicator contained in each trace record 120. This beneficially allows the correlation server 106 to generate the correlated trace record 400 to include only the information that is pertinent to the particular instance of the use case. All other information (i.e., information associated with other use cases) is not included in the correlated trace record 400.

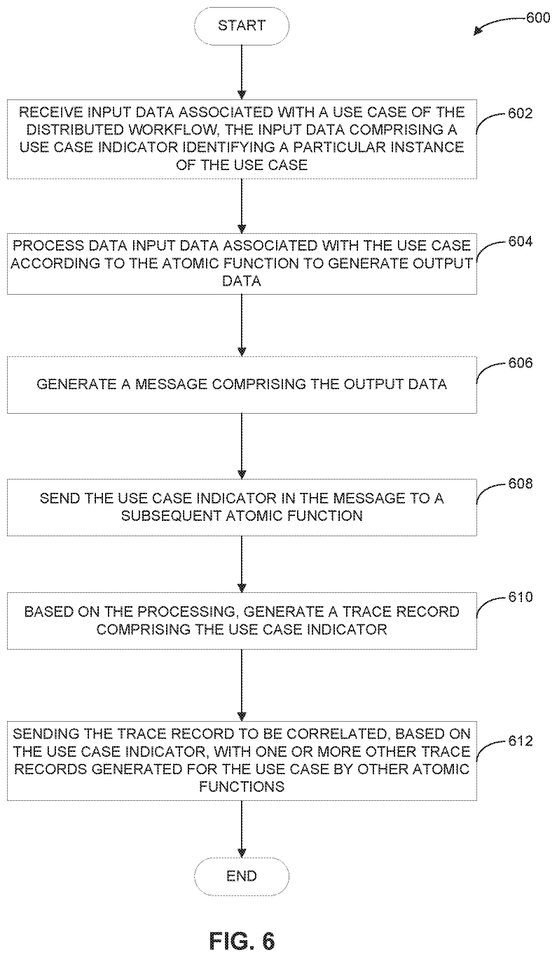

FIG. 6 is a flow diagram illustrating an exemplary method 600 for generating a trace record 120 by a network node functioning in a “continuer role” according to one aspect of the present disclosure. Such a network node may be, for example, network node 104b.

As seen in FIG. 6, network node 104b first receives input data associated with a use case being processed as part of a distributed network flow (box 602). The input data, which may comprise the output message generated and sent by network node 104a, for example, includes the use case indicator identifying the use case and a particular instance of that use case. Then, network node 104b, and more specifically, AF 108b, processes the input data to generate output data (box 604) and generates an output message 114b comprising the output data and the use case indicator 410 (box 606). The generated output message 114b, along with the use case indicator 410, is then sent to another downstream AF executing on a downstream network node (box 608).

Further, according to the present disclosure, AF 108b generates, based on the AF processing, a trace record 120b comprising the use case indicator 410 (box 610). Once generated, network node 104b sends the trace record 120b to correlation server 106 to be correlated with the other trace records 120 generated and sent by other AFs 108 on the same or other network nodes 104 (box 612).

In some embodiments of methods 500 and/or 600, as stated above, the use case indicator 410 comprises a pre-determined use case ID that is unique to the use case and remains unchanged throughout the distributed workflow.

The pre-determined use case ID may comprise one or more of a descriptive label describing associated with the use case, a link ID associated with the use case, and a report ID associated with an alarm detected by the network node.

In some embodiments of methods 500 and/or 600, as stated previously, the use case indicator 410 further identifies the particular instance of the use case with a unique use case instance ID.

In these cases, the use case instance ID may comprise, for example, one or more of a process ID of the use case instance, a randomly generated alphanumeric ID, and a pre-determined label.

In some embodiments of methods 500 and/or 600, the trace record 120 is generated to further comprise a timestamp 402, 404 indicating when trace record 120 was generated, and information associated with an activity performed by the AF 108 relative to the use case.

In some embodiments, methods 500 and/or 600 may further comprise generating an output message 114 comprising the output data and sending the use case indicator 410 in the output message 114 to a subsequent AF 108 executing on the same or different network node 104.

In some embodiments of methods 500 and/or 600, the use case indicator 410 is sent to the subsequent AF in a header of the message.

In some embodiments of methods 500 and/or 600, the AF 108 and one or more of the other AFs 108 are executed by the same network node 104.

In some embodiments of methods 500 and/or 600, however, the AFs are executing on different network nodes 108. In these cases, the network node 104 executing the AF is a first network node (e.g., network node 104a), and wherein one or more of the other AFs 108 are executed by a second network node 104 (e.g., network node 104b) that is different than the first network node.

In some embodiments of methods 500 and/or 600, the first and second network nodes operate in first and second different communication networks.

In some embodiments of methods 500 and/or 600, the use case is traced from a time when the use case is instantiated to a time when the use case is complete.

In some embodiments of method 500 the network node 104 is an initiator node configured to instantiate the use case.

In some embodiments of method 600, the network node 104 is a continuer node disposed downstream from the initiator node.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

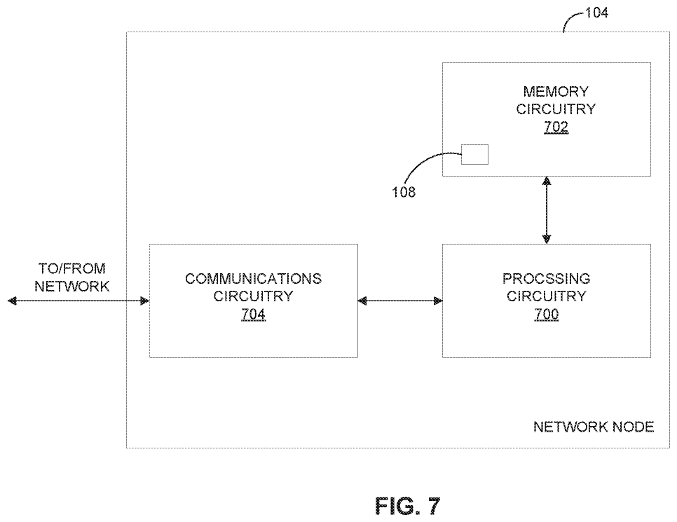

FIG. 7 is a schematic diagram illustrating some exemplary components of a network node 104 configured to implement aspects of the present disclosure. It should be noted that network node 104 illustrated in FIG. 7 may be a network node operating in an initiator role, such as network node 104a, or in a continuer role, such as network node 104b or 104c, or in a terminating role, such as network node 104d.

As seen in FIG. 7, network node 104 comprises processing circuitry 700, memory circuitry 702, and communications circuitry 704. The processing circuitry 700 controls the overall operation of the network node 104 and implements the methods as herein described. The processing circuitry 700 may comprise one or more microprocessors, hardware, firmware, or a combination thereof, and according to the present disclosure, is configured to perform one or more of the methods shown in FIGS. 5 and 6.

More particularly, in an embodiment where the network node 104 functions in an initiator role, the processing circuitry 700 is configured to generate a use case indicator for a use case associated with the distributed workflow, process input data associated with the use case according to an AF 108 to generate output data, generate, based on the processing, a trace record comprising the use case indicator, and send the trace record to be correlated, based on the use case indicator, with one or more other trace records generated for the use case by other AFs 108.

In an embodiment where network node 104 performs a continuer or terminating role, processing circuitry 700 is configured to receive input data associated with a use case of the distributed workflow, wherein the input data comprises a use case indicator identifying a particular instance of the use case, process the input data according to an AF to generate output data, generate, based on the processing, a trace record comprising the use case indicator, and send the trace record to be correlated, based on the use case indicator, with one or more other trace records generated for the use case by other atomic functions.

Memory 702 comprises both volatile and non-volatile memory for storing computer program code and data needed by the processing circuit 700 for operation. Memory 702 may comprise any tangible, non-transitory computer-readable storage medium for storing data including electronic, magnetic, optical, electromagnetic, or semiconductor data storage. Memory 702 stores a computer program such as AF 108 comprising executable instructions that configure the processing circuitry 700 to implement the methods according to FIGS. 5 and/or 6 as described herein. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, the computer program such as AF 108 as herein described may be stored in a removable memory, such as a portable compact disc, portable digital video disc, or other removable media. The computer program may also be embodied in a carrier such as an electronic signal, optical signal, radio signal, or computer readable storage medium.

The communication circuitry 704 comprises the hardware and software required for communication between network nodes 104 over IP network 102. For example, in one embodiment, communication circuitry 704 comprises an ETHERNET circuit for communicating with the other network nodes 104a. In another embodiment, however, communication circuitry 704 comprises RF circuitry for communication between network nodes over a RF channel.

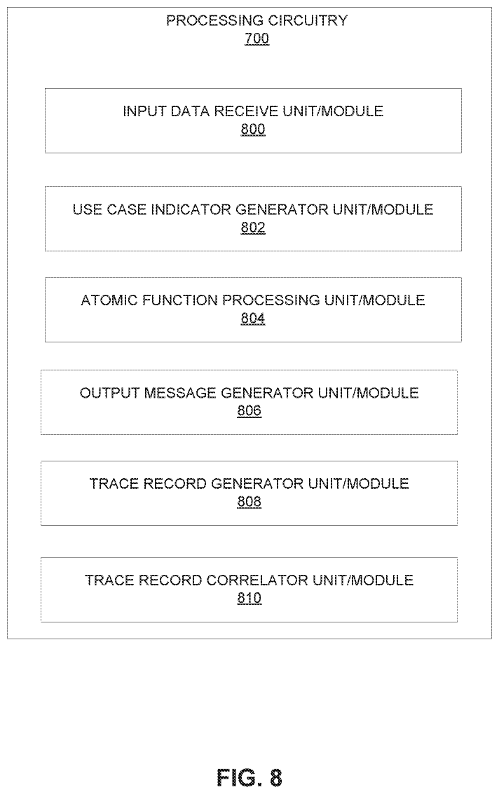

FIG. 8 is a functional block diagram illustrating a computer the processing circuitry 700 of a network node 104 configured to implement aspects of the present disclosure. As seen in FIG. 8, processing circuitry 700 executes a plurality of units/modules including an input data receive unit/module 800, a use case indicator generator unit/module 802, an atomic function (AF) processing unit/module 804, an output message generator unit/module 806, a trace record generator unit/module 800, and a trace record correlator unit/module 810. Each of the unit/modules may be implemented, for example, as hardware and/or software code implemented by processing circuitry 700.

The input data receive unit/module 800 comprises instructions that, when executed by processing circuitry 700, configures network node 104 to receive input data from an upstream AF 108, as previously described. The use case indicator generator unit/module 802 comprises instructions that, when executed by processing circuitry 700, configures network node to generate a unique use case indicator, as previously described. The AF processing unit/module 804 comprises instructions that, when executed by processing circuitry 700, configures network node 104 to process the received input data according to the atomic function 108, as previously described. The output message generator unit/module 806 comprises instructions that, when executed by processing circuitry 700, configures network node to generate and send an output message 114 comprising the generated output data and the use case indicator 410 to a downstream network node 104, as previously described. The trace record generator unit/module 808 comprises instructions that, when executed by processing circuitry 700, configures network node to generate a trace record 120 comprising, inter alia, the use case indicator 410, as previously described. The trace record correlator unit/module 810 comprises instructions that, when executed by processing circuitry 700, configures network node to send the generated trace record 120 to correlation server 106 to be correlated with one or more other trace records 120 generated by one or more other AFs 108 executing on the same or different network node 104.

With the above in mind, embodiments of the present disclosure provide benefits and functionality that conventional techniques and processes do not provide. For example, conventional methods produce an undesirable amount of information when logging. Most of that information is not relevant to an issue of interest. Thus, when analyzing the data in connection with that issue, an analyst is hindered by vast amounts of irrelevant data. The present embodiments, however, produce trace records that are easily correlated with other trace records generated for the same use case instance. Therefore, analysts reviewing the correlated traces of the present embodiments, do not need to sift through a voluminous amount of irrelevant data.

Further, embodiments of the present disclosure may be utilized in a wide variety of situations. For example, in a development phase of a project, the present embodiments can be used to identify and/or correct customer needs and requirements for application features. In testing scenarios, the present embodiments can assist a user to find and solve different malfunctions and/or validate application features. In a live network scenario, the present embodiments beneficially provide a systems analyst with an accurate trace of salient information.

Additionally, the present embodiments are beneficial across a wide range of life-cycle stages of a product. Such stages include, but are not limited to:

### Design

During a design phase of a project, use cases can be constantly tracked during all the development stages. The interactions between different technical areas are therefore improved.

### Release Verification

In this phase of a project, the identification of use cases in general system tests optimize interactions between a testing unit and the design teams. It can particularly allow for the easy identification of a specific point of a specific use case causing the system test failure.

### Customer Support

In this aspect, when a need for investigation arises, the present embodiments identify the particular use case. Indeed, this simplifies the analysis and allows the user to focus on an issue of interest without having to identify and filter out all the irrelevant trace information (i.e., “noise”). Additionally, because the correlated trace records contain only the salient information and data, the present embodiments minimize data transfer from the distributed system experiencing an issue to customer support premises. Minimizing the amount of data and information also allows analysts to focus only on relevant information, which helps mitigate the risk of unintentionally exposing sensitive data (both from a privacy and a security point of view). Moreover, such focus also optimizes interactions between customer support and design teams thereby assisting in any advance troubleshooting activities.

### Audit

The present embodiments also allow a customer support team, and by extension, product designers, to better understand and classify the way users work and interact with a product. It also provides a better understanding of how to deploy and implement the product.

Moreover, embodiments of the present disclosure can better identify areas for system improvement and individual use case performance. Such information can come, from example, an analysis of the success/failure rate for a given use case.

### Security

Additionally, with the present embodiments, customers can limit access to their premises. That is, because the present embodiments provide only relevant information, the analysis and troubleshooting activities are optimized. This may allow support personnel, for example, to identify an particular problem and address the problem without having to access the customer's site. Therefore, access to the customer's premises can be significantly reduced to a minimum if not excluded altogether.

Further, reducing the need to physically access the customer's site implies increased remote access abilities for individuals located in different countries around the world. Thus, the inadvertent disclosure of information regarding customer deployment is also significantly reduced.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Embodiments of the present disclosure may, of course, be carried out in other ways than those specifically set forth herein without departing from essential characteristics of the present disclosure. The present embodiments are therefore to be considered in all respects as illustrative and not restrictive, and all changes coming within the meaning and equivalency range of the appended claims are intended to be embraced therein.

1. A method for managing telecommunication networks implemented by a network node executing an atomic function in a distributed workflow, the method comprising:
determining whether a use case indicator is received as input for the atomic function, the use case indicator identifying a use case and a particular instance of the use case, the use case being a scenario in which a distributed network receives an external request and responds to the external request;
if the use case indicator is not received as input by the atomic function, generating the use case indicator for the use case associated with the distributed workflow;
processing data input data associated with the use case according to the atomic function to generate output data, the atomic function being associated with tracing in the distributed workflow and comprising a set of uninterruptible instructions executable by the network node;
based on the processing, generating a trace record comprising the use case indicator; and
sending the trace record to be correlated, based on the use case indicator, with one or more other trace records generated for the use case by other atomic functions, the atomic function and one or more of the other atomic functions being executed by the network node.

2. (canceled)

3. (canceled)

4. The method of claim 1, wherein the use case indicator comprises a pre-determined use case ID that is unique to the use case and remains unchanged throughout the distributed workflow.

5. The method of claim 1, wherein the pre-determined use case ID comprises one or more of:
a label associated with the use case;
a link ID associated with the use case; and
a report ID associated with an alarm detected by the network node.

6. The method of claim 1, wherein the use case indicator further identifies the particular instance of the use case with a unique use case instance ID.

7. The method of claim 6, wherein the use case instance ID comprises one or more of:
a process ID of the use case instance;
a randomly generated alphanumeric ID; and
a pre-determined label.

8. The method of claim 1, wherein the trace record is generated to further comprise a timestamp indicating when the trace record was generated, and information associated with an activity performed by the atomic function relative to the use case.

9. The method of claim 1, further comprising generating a message comprising the output data and sending the use case indicator in the message to a subsequent atomic function.

10. The method of claim 9, wherein the use case indicator is sent to the subsequent atomic function in a header of the message.

11. (canceled)

12. The method of claim 1, wherein the network node executing the atomic function is a first network node, and wherein one or more of the other atomic functions are executed by a second network node that is different than the first network node.

13. The method of claim 12, wherein the first and second network nodes operate in first and second different communication networks.

14. The method of claim 1, wherein the use case is traced from a time when the use case is instantiated to a time when the use case is complete.

15. The method of claim 1, wherein the network node is an initiator node configured to instantiate the use case.

16. The method of claim 1, wherein the network node is a continuer node disposed downstream from the initiator node.

17.-19. (canceled)

20. A network node in a distributed communications environment for managing telecommunication networks, the network node being configured to execute an atomic function in a distributed workflow and comprising:
communication circuitry enabling communication with one or more other atomic functions in the distributed communications environment; and
processing circuitry configured to:
determine whether a use case indicator is received as input for the atomic function, the use case indicator identifying a use case and a particular instance of the use case, the use case being a scenario in which a distributed network receives an external request and responds to the external request;
if the use case indicator is not received as input by the atomic function, generate the use case indicator for the use case associated with the distributed workflow;
process data input data associated with the use case according to the atomic function to generate output data, the atomic function being associated with tracing in the distributed workflow and comprising a set of uninterruptible instructions executable by the network node;
based on the processing, generate a trace record comprising the use case indicator; and
send the trace record to be correlated based on the use case indicator with one or more other trace records generated for the use case by other atomic functions, the atomic function and one or more of the other atomic functions being executed by the network node.

21. The network node of claim 20, wherein the use case indicator comprises a pre-determined use case ID that is unique to the use case and remains unchanged throughout the distributed workflow.

22. A computer storage medium storing a computer program comprising executable instructions that, when executed by a processing circuitry in a network node, causes the network node to perform a method for managing telecommunication networks implemented by a network node executing an atomic function in a distributed workflow, the method comprising:
determining whether a use case indicator is received as input for the atomic function, the use case indicator identifying a use case and a particular instance of the use case, the use case being a scenario in which a distributed network receives an external request and responds to the external request;
if the use case indicator is not received as input by the atomic function, generating the use case indicator for the use case associated with the distributed workflow;
processing data input data associated with the use case according to the atomic function to generate output data, the atomic function being associated with tracing in the distributed workflow and comprises a set of uninterruptible instructions executable by the network node;
based on the processing, generating a trace record comprising the use case indicator; and
sending the trace record to be correlated, based on the use case indicator, with one or more other trace records generated for the use case by other atomic functions, the atomic function and one or more of the other atomic functions being executed by the network node.

23.-30. (canceled)
